(19) United States
(12) Patent Application Publication
(10) Pub. No.: US 2005/0117604 A1
(43) Pub. Date: Jun. 2, 2005

(54) Transport layer protocol for a peripheral module for a communication device

(76) Inventors: Rasmus Villefrance, Helsinge (DK); Jesper Sandberg, Valby (DK)

Correspondence Address: PERMAN & GREEN, 425 POST ROAD, FAIRFIELD, CT, 06824, US

(21) Appl. No.: 10/716,646

(22) Filed: Nov. 19, 2003

(51) Int. Cl. H04J 3/16

(52) U.S. Cl. 370/469

(57) ABSTRACT

This invention relates to a method for establishing a transport layer protocol that enables data communication between a variety of modules in a communication system. The modules may be a mobile communication device (254) and a plurality of peripherals (264). In addition, this invention relates to a data package configured according to a transport layer protocol.

### FIELD OF INVENTION

This invention relates to a method for establishing a transport layer protocol that enables data communication between a variety of modules in a communication system. The modules may be a mobile communication device such as a cell or mobile telephone, and a peripheral product for a cell or mobile telephone, such as for example a camera or a headset also known as enhancements. In addition, this invention relates to a data package configured according to a transport layer protocol.

### BACKGROUND OF INVENTION

American patent application entitled “Method and system establishing a data link layer protocol on a I²C physical layer connection”, by the same applicant, discloses a method for establishing a data link layer connection enabling data communication between a plurality of modules connected to an I²C-bus. Similarly, International Patent Application PCT/IB03/3868, also by the same applicant, discloses a method and system for establishing a data link layer protocol on a physical layer port connection. The objects of the inventions presented in the American and international patent applications are to provide a data link layer protocol providing forward and backward compatibility in an I²C-bus type network and through a UART port connection, respectively, and to provide a data link layer protocol, which enables data communication between modules connecting to an I²C-bus or a UART port, respectively, and using a wide variety of transport layer protocols. The American and International patent applications are hereby incorporated by reference.

Even though the above referenced prior art disclosures provide a fundament of technology further problems still exists, which are to be solved in light of said disclosures. Firstly, neither of the disclosures describe an independent transport layer protocol. The American patent application describes a data link layer protocol for an I²C connection and the International Patent Application describes a data link layer protocol for a port connection.

Further, whenever data is to be transferred from a mobile communication device to a peripheral module through any connection there is a need for establishing overall compatibility between them.

Generally, a proprietary transport layer protocol exists for establishing communication between a mobile communication device and a peripheral. The proprietary transport layer protocol, however, does not allow for changes in the mobile communication device software hence resulting in fatal errors in the communication between the mobile communication device and the peripheral.

### SUMMARY OF THE INVENTION

In light of the above it is an object of the present invention to provide a transport layer protocol allowing peripherals to get access to resources of a mobile communication device.

A particular advantage of the present invention is provision of a standardized format for communication ensuring forward and backward compatibility between a mobile communication device and connecting peripherals.

A particular feature of the present invention relates to the provision of a transport layer protocol enabling a specific peripheral to operate on a plurality of different mobile communication devices and/or different mobile communication device software.

The above object, advantage and feature together with numerous other objects, advantages and features, which will become evident from below detailed description, are obtained according to a first aspect of the present invention by a system for providing data communication between connected modules, wherein said modules are adapted to transmit to and receive from one another a data package comprising in a layered structure a physical layer comprising a first and a second segment for encapsulating other layers in said data package, a data link layer comprising a data link layer control section for carrying data link layer control data and a data section for carrying data for said other layers, and a transport layer defining a message in said data section, which message is configured according to a transport layer protocol and comprises a payload and a first header field for format of said payload, a second header field for start of said payload in said message, a third header field for length of said message, a fourth header field for version of said transport layer protocol, and a fifth header field for message group identity establishing receiving resource format of said payload.

In this context the term “data package” is to be construced as a block of data, a data packet or a datagram to be communicated between two modules. The data package may be defined according to a reference model comprising a plurality of layers. For example, a reference model may comprise seven layers. The first layer, the physical layer, generally conveys a bit stream through a network at the electrical and mechanical level. The second layer, the data link layer, provides synchronization for the physical level and does bit-padding. The third layer, a transport/network layer, handles the routing of the data and manages the end-to-end control and error-checking. The upper three layers, namely application, presentation, and session layers, are generally used whenever a message passes from or to a user.

Further, in this context the term “message” is to be construed as a data segment of the data link layer, that is, the data which are intended for further layers, and the term message is to be construed as the transport layer part of the data package. The message also holds a data segment which in this context is named payload of the message.

The system according to the first aspect of the present invention provides forward and backward compatibility of data packages to be communicated through a communication system such as between a mobile communication device and a peripheral. The physical and data link layer protocols may be changed without compromising the message. In addition, by configuring the transport layer of the data package as described above it is ensured that the system may be operated with a plurality of simultaneous correspondence.

The modules according to the first aspect of the present invention may comprise a mobile communication device such as a cell, mobile or satellite telephone, a personal digital assistant, or a peripheral thereto. Further, the modules may comprise one or more objects communicating the message with one another, and a data link layer generator and a physical layer generator adapted to encapsulate the message according to a data link layer protocol and to a physical layer protocol, respectively.

The term peripheral is in this context to be construed as an enhancement, functional cover, or an assessory to a mobile communication device, such as a camera module, GPS module, keyboard module, sound module or similar modules.

The one or more objects may be software implemented functions run separately or concurrently on the modules. That is, the objects may relate to operating system operations or application layer operations. Changes to the software in the prior art technologies generally caused an unstable system, since message interface may change thereby disabling the peripherals. Earlier operative system interfaces were frozen, i.e. constraints were added to the mobile communication device software. Hence some errors could not be corrected and some features could not be extended, e.g. in prior art technologies it was not possible to improve image quality of a camera to more than 64 Kbyte due to inherent limitations of the transport layer protocol.

To the contrary, in the present invention the software of the mobile communication device is not constrained by peripherals, thus enabling peripherals to operate on a wide variety of mobile communication devices thereby expanding the lifetime of the peripherals.

The transport layer according to the first aspect of the present invention may further comprise a sixth header field for a message identity for uniquely identifying a message type in the message group identity, a seventh header field for a connection number for identifying a communicating object in the module, an eight header field for a transaction identity for sequencing the message relative to other messages, and a ninth header field for a future extension comprising information required by a future transport layer protocol.

This transport layer of the data package ensures that the system may handle a multiplicity of simultaneous messages and that each of the messages is grouped in accordance with a particular resource. That is, the messages relating to operating system operations are grouped together.

The data link control data according to the first aspect of the present invention may comprise a checksum field following the message in the data package. The data link control data may generally take any form using any data link layer protocol.

The first segment of the physical layer according to the first aspect of the present invention may comprise a media field for defining media across which the data package is transferred, a synchronization field for synchronizing the receiving module with the transmitting module. The media field may define a plurality of connection types known to the person skilled in the art.

The second segment of the physical layer according to the first aspect of the present invention may comprise an index byte for providing the receiving module with information regarding segmentation or partitioning of data contained in a message. This is particularly advantageous when the data package to be transmitted is longer than allowed by the port connector or the receiving module. Further, the second segment may comprise a parity field for storing parity calculated on the basis of the data package excluding the parity field, a sequence and acknowledge field for providing a receiving module with information whether the data package is an acknowledgement message or an ordinary message, a fill field for ensuring that all data packages sent over the port connector contain an even amount of bytes, and a sequence and acknowledge field is adapted to inform whether an error was identified in the received data package, when the data package is an acknowledgement message.

The sequence and acknowledgement field according to the first aspect of the present invention may be adapted to inform a receiving module that a sequence number in the receiving module should be reset. Further, the sequence and acknowledgement field may be adapted to recognise acknowledgement messages and detect missing data packages.

The above object, advantage and feature together with numerous other objects, advantages and features, which will become evident from below detailed description, are obtained according to a second aspect of the present invention by a data package for communicating between modules, wherein said data package comprising in a layered structure physical layer data comprising a first and a second segment for encapsulating other layers in said data package, a data link layer comprising a data link layer control section for carrying data link layer control data and a data section for carrying data for said other layers, and a transport layer defining a message in said data section, which message is configured according to a transport layer protocol and comprises a payload and a first header field for format of said payload, a second header field for start of said payload in said message, a third header field for length of said message, a fourth header field for version of said transport layer protocol, and a fifth header field for message group identity establishing receiving resource format of said payload.

The data package according to the second aspect of the present invention may incorporate any features of the system according to the first aspect of the present invention.

The above object, advantage and feature together with numerous other objects, advantages and features, which will become evident from below detailed description, are obtained according to a third aspect of the present invention by a receiver unit adapted to receive a data package according to the second aspect of the present invention.

The above object, advantage and feature together with numerous other objects, advantages and features, which will become evident from below detailed description, are obtained according to a fourth aspect of the present invention by a transmitter unit adapted to transmit a data package according to the second aspect of the present invention.

The above object, advantage and feature together with numerous other objects, advantages and features, which will become evident from below detailed description, are obtained according to a fifth aspect of the present invention by a method for establishing data communication between modules, wherein said modules each communicate a data package comprising in a layered structure a physical layer comprising a first and a second segment for encapsulating other layers in said data package and a data link layer comprising a data link layer control section for carrying data link layer control data and a data section for carrying data for said other layers, and wherein said method comprising: providing in said data package in a transport layer a message in said data section, which message is configured according to a transport layer protocol and comprises a payload and a first header field for format of said payload, a second header field for start of said payload in said message, a third header field for length of said message, a fourth header field for version of said transport layer protocol, and a fifth header field for message group identity establishing receiving resource format of said payload.

The method according to the fifth aspect of the present invention may incorporate any features of the first, second, third and fourth aspect of the present invention.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawing, wherein:

FIG. 1a, shows an example of a physical layer (data frame) and data of a data package to be transferred through a port connection,

FIG. 1b, shows an example of a physical layer (data frame) and data of a data package to be transferred through a I²C connection,

FIG. 1c, shows a data link layer of a data package,

FIG. 1d, shows a transport layer of a data package according to the preferred embodiment of the present invention,

FIG. 2, shows an example of usage of the preferred embodiment according to the present invention, and

FIG. 3, shows a flow chart of the usage of the preferred embodiment according to the present invention.

### DETAILED DESCRIPTION OF PREFERRED EMBODIMENTS

In the following description of the various embodiments, reference is made to the accompanying drawing which form a part hereof, and in which by way of illustration various embodiments are shown in which the invention may be practiced. It is to be understood that other embodiments may be utilized and structural and functional modifications may be made without departing from the scope of the present invention.

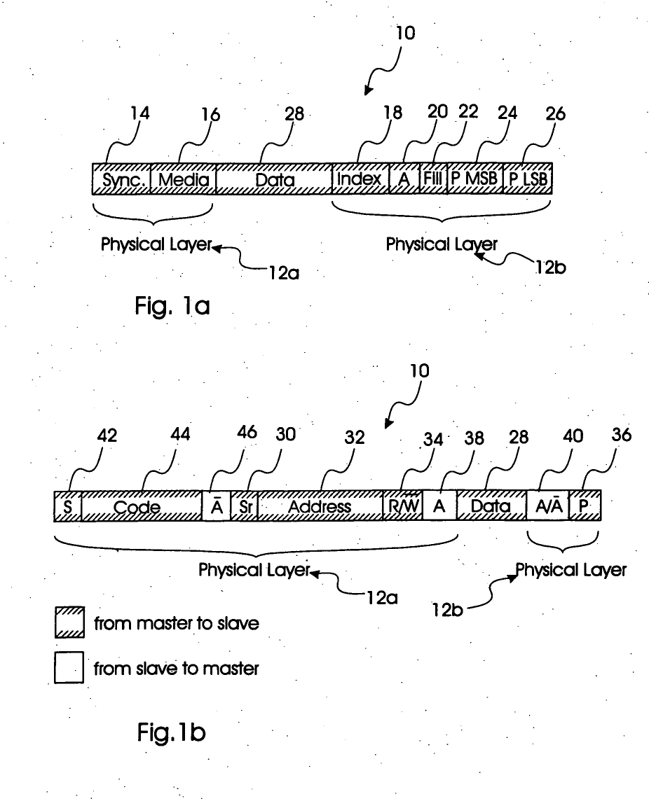

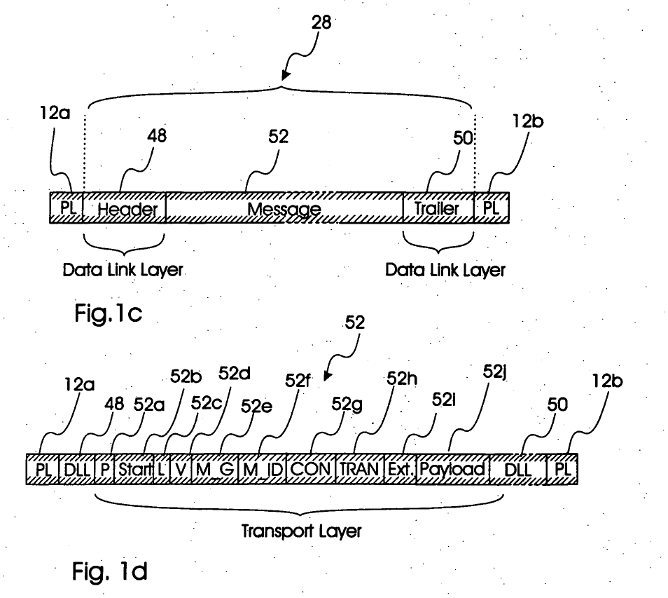

FIG. 1a shows an example of a data package 10 comprising a physical layer or data frame 12a, 12b encapsulating data to be communicated through a port connection. The data frame 12a, 12b comprises a first segment 12a before the data segment and a second segment 12b tailing the data segment.

The first segment 12a comprises synchronization bytes 14 for synchronizing the modules connected through the port connection. The synchronization bytes 14 comprise 8 bytes containing 55h (hexadecimal corresponding to a series of “0” and “1”). Following the synchronization bytes 14 the transmitting module enters a wait state for 20 ms thereby allowing the receiving module to synchronize. It should be noted that the synchronization bytes 14 may by defined as a preliminary state of a transmission state not part of the physical layer of a data package.

Following the synchronization bytes 14 the first segment 12a of the physical layer comprises a media byte 16, which is used to describe the physical media, across which the data package is transferred. The media byte 16, further in some instances as described below, describes which type of data is encapsulated in the data segment by the physical layer.

The second segment 12b comprises an index byte 18 providing the receiving module with information regarding segmentation or partitioning of data contained in a message. That is, when a message is larger than allowed for by the data package size.

The index byte 18 may comprise values from 1 to 255, and in case of no segmentation of the message the value is 1. In case, the message is divided into 3 segments the first index byte 18 of the first data package comprising a first part of the segmented message has a value of 3, the second data package comprising a second part of the segmented message has a value of 2, and lastly the final data package comprising a final part of the segmented message has a value of 1.

The second segment 12b further comprises a sequence and acknowledge byte 20, which has several purposes. The first bit (the most significant bit (MSB)) provides information whether the data package is an acknowledgement message or an ordinary message. If the first bit is “1”, then it is not necessary to send an acknowledgement message back. Generally, external modules, such as mobile telephone enhancement devices, request acknowledgement messages to be returned and therefore the first bit in these instances is “0”. In a returned acknowledgement message the first bit is used to inform whether an error was identified in the received data package.

The second bit in the acknowledgement byte 20 when set to “1” is a further indication of a first data package of a plurality of data packages defining a message.

The third bit in the acknowledgement byte 20 when set to “1” informs the receiving module that the receiving module's RX sequence number should be reset. The third bit is normally set to “1”, in the first data package received by the module and “0” in all subsequent data packages.

The fourth and fifth bit in the acknowledgement byte 20 are at present set to “0”.

The three least significant bits namely sixth, seventh and eighth bit in the acknowledgement byte 20 is used for recognizing acknowledgement messages and for detecting missing data packages. Every module has to maintain both a TX and RX sequence number and these two sequence numbers are independent of each other. For outgoing data packages (except acknowledgement messages) each module must increase the sequence number each time a data package is sent. For incoming data packages each module checks the used sequence number and ensures that it is increased by one. If this is not the case, then the sequence number error bit (the first bit) must be set in the acknowledgement message returned to the transmitting module.

The second segment 12b further comprises a fill byte 22 used for ensuring that all data packages sent over the port connector contain an even amount of bytes. This is particularly required in case a 16 bit parity calculation is used.

The second segment 12b finally comprises a first and second parity byte 24, 26 for storing 16 parity calculated on all 16 bit words in the data package excluding the parity field. When a module receives a data package it must calculate parity of the data package and compare this calculated parity with the contents of the first and second parity bytes 24, 26, and if the calculated parity is not equal to the contents of the first and second parity bytes 24, 26, then the data package is to be discarded without sending an acknowledgement message.

FIG. 1b shows an example of a data package 10 comprising a physical layer or data frame 12a, 12b encapsulating data to be communicated through a I²C connection in a high speed transfer mode. The data frame 12a, 12b comprises a first segment 12a before the data segment 28 and a second segment 12b tailing the data segment 28. The I²C-bus specification specifies a “start condition” 30 prior to transmission on the I²C-bus and consisting of a 7-bit “address” 32 of the receiving IC. The address 32 is followed by a data direction bit 34, where a “0” indicates “WRITE” and a “1” indicates “READ”, and the data frame 10 is terminated by a “stop condition” 36. Subsequent to receiving the data direction bit 34 the I²C specification requires the data receiving IC to acknowledge reception of the address 32 and the data direction bit 34 by forwarding an acknowledgement bit 38, accomplished by pulling the first wire of the I²C-data bus “0”. Following reception of the acknowledgement bit 38 the data transmitting IC initiates transmission of data 28. The last data byte is acknowledged by a final acknowledgement bit 40.

The data frame 10 further comprises a further “start condition” 42, an 8-bit “code” 44 and a “not-acknowledgement bit” 46 preceding the “start condition” 30.

The above examples of physical layer structures are to be construed as examples only, since the physical layer may further be structured in accordance with Bluetooth or any other protocols known to a person skilled in the art.

FIG. 1c, shows a data link layer of the data package 10. The data link layer comprises a header section 48 containing information such as data link layer protocol identification, and a trailer section 50 containing information such as checksum value. The contents of the header 48 and trailer 50 sections are in accordance with the data link layer protocol to which the communication adheres to. Some data link layer protocol require a trailer section 50 and some do not. A transport layer message 52 is comprised in the data package 10 between the header and trailer (if one present) sections 48 and 50.

The transport layer message 52 according to the preferred embodiment of the present invention, as shown in FIG. 1d, utilises the data frame 10, shown in FIG. 1a or 1b, as a physical layer and the data part 28, shown in FIG. 1b, as a data link layer in a reference model.

The transport layer message 52 according to the preferred embodiment of the present invention is incorporated into the data frame 10 carrying the communication between modules, such as between mobile communication devices and peripherals, by packaging the message 52 to be transferred into the data frame 10 in a format shown in table 1 below.

TABLE 1
General format for messages

| Size in | | |
|---|---|---|
| bytes | Name | Comment |
| 1 | PROTOCOL | Format of the payload in the |
| | | transport layer data field. |
| 1 | DATA START | Start byte number (or offset) |
| | | for the data field. |
| 2 | LENGTH | Length of the transport layer |
| | | message. |
| 2 | VERSION | Version number of the transport |
| | | layer protocol. |
| 1 | MSG_GROUP | Message group |
| 1 | MSG_ID | Message identity. |
| 1 | CONNECTION_NO | Connection number for multiple |
| | | simultaneous connections. |
| 1 | TRANSACTION_ID | Transaction identity for |
| | | multiple simultaneous requests. |
| N1 | Future | Fields which can be used for |
| | extensions | extensions of the transport |
| | | layer protocol. |
| N2 | DATA | Payload, formatted as defined in |
| | | the transport layer protocol. |

PROTOCOL 52a

The PROTOCOL field 52a describes the protocol used for a transport layer message 52. That is, the format of the DATA field 52g i.e. the payload. Two protocols are at present defined. The first protocol, PROT_SIMPLE, is used for handling proprietary messages such as messages that map to operative system messages. The second protocol, PROT_LOCAL is used for local issues such as protocol set-up and parameter negotiation. Additionally, it is anticipated that TCP/IP, HTTP, and/or any product proprietary protocols may be coded.

DATA_START 52b

The DATA_START field 52b comprises an offset in bytes from the beginning of the message 52, to where the DATA field 52j starts. This field 52b is incorporated into the header section of the message 52 to make the header backward compatible. When future fields are added to the header, any software may forward payload data even though the software is aware of the additional fields. The software may forward the data payload in the DATA field 52i based on the DATA START field 52b, the VERSION field 52d and the PROTOCOL field 52a.

The DATA_START field 52b is required for maintaining flexibility in the header section of the message 52, and it provides the opportunity to create specific headers, which might be developed in the future. The DATA_START field 52b is zero indexed, i.e. if the DATA field 52j starts on the 9^{th} byte, then DATA_START 52b has a value of 8.

The DATA_START field 52b must be even so as to ensure that the DATA field 52j is aligned on an even address. Aligning data on odd addresses may cause problems for some processors.

LENGTH 52c

The LENGTH field 52c comprises the length of the complete message 52, including the payload in the DATA field 52j.

VERSION 52d

The VERSION field 52d describes the version of the header section of the message 52. Table 2 below shows examples of how version information is encoded in the header.

TABLE 2
Encoding of version information

| | Version field 52d |
|---|---|
| Protocol version | (HEX value) |
| 1 | 0100H |
| 2.3 | 0203H |

MSG_GROUP 52e

The MSG_GROUP field 52e comprises information regarding grouping of the message 52. Messages for a given protocol are grouped into several message groups depending on, to which software resource they belong in an operating system such as Symbian.

MSG_ID 52f

The MSG_ID field 52f together with the MSG_GROUP 52e uniquely describes the payload in the DATA field 52j. If, for example, the payload is a parameter change request, then the MSG_ID 52f has a first value, and if the payload is for a parameter change response, the MSG_ID 52f has a second value. The number is unique for a given transport layer protocol, for example, the numerical value of the field 52f has different meanings when the first or second protocol is claimed in the PROTOCOL field 52a.

CONNECTION_NO 52g

The CONNECTION_NO field 52g comprises the connection number also known as the object number of the transmitting object in the peripheral. The number enables the peripheral to have a plurality of simultaneous connections. The connection number is local for a given peripheral, which means that if two peripherals are connected simultaneously to the mobile communication device, then they may both use the same connection number. The command parser in the mobile communication device combines the object number with the device number obtained from the data link layer with the device number of a given peripheral in order to uniquely identify each connection.

TRANSACTION_ID 52h

The TRANSACTION_ID field 52h specifies the transaction identity of the message 52. This functionality is required when a message is transmitted before the answer of a previous message has been received, since there are no guarantees that the sequence is kept.

For example, when two requests, A and B, are sent immediately after one another, the TRANSACTION_ID field 52h provides information for determining which response comes first A or B.

Extension 52i

The extension field 52i compensates for future extensions of the header section of the message 52 due to new transport layer protocols. There might be a need in the future for additional fields in the header section of the message 52. These extensions can be added while still being backward compatible, the DATA_START field 52b provides the receiving module with information as to where the actual DATA field 52j starts.

The extension field 52i provides the means for handling backward compatibility since it provides the possibility to add further header fields to the message 52. The DATA_START field 52b enables the extension concept to be utilised, since the DATA_START field 52b assures that the receiving module may always identify the location of the DATA field 52j, no matter how many extensions are inserted.

DATA 52j

The DATA field 52j comprises the actual payload. The format of the payload is determined by the value of the PROTOCOL field 52a. The content of DATA field 52j (i.e. the payload) is the only part of the message 52, which is forwarded to the upper layers, namely application, presentation and session layers. The payload data in the DATA field 52j is discarded, if the value of the PROTOCOL field 52a is unknown or unsupported in the protocol version.

The variable N2 for the DATA field 28 g byte length is of even values between 0 and 1536.

Examples of Use of the Transport Layer Protocol

Uses of the transport layer protocol according to the preferred embodiment of the present invention are described below by way of examples, in which a mobile communication device communicates with a peripheral utilising the transport layer structure as described above.

In a connectionless protocol a peripheral is not required to create a connection before communicating the first message, such as shown in FIG. 1d as reference numeral 52. This means that any message may be transmitted at any time. The peripheral should be able to handle no response from the mobile communication device. The mobile communication device may, for example, be busy and therefore unable to respond. The order in which messages are communicated from the peripheral to the mobile communication device or from the mobile communication device to the peripheral is not fixed. If a peripheral communicates an indication subscription request, which generates an indication immediately, it is not possible to determine whether the indication or the indication subscription response is to be the first message communicated to the peripheral.

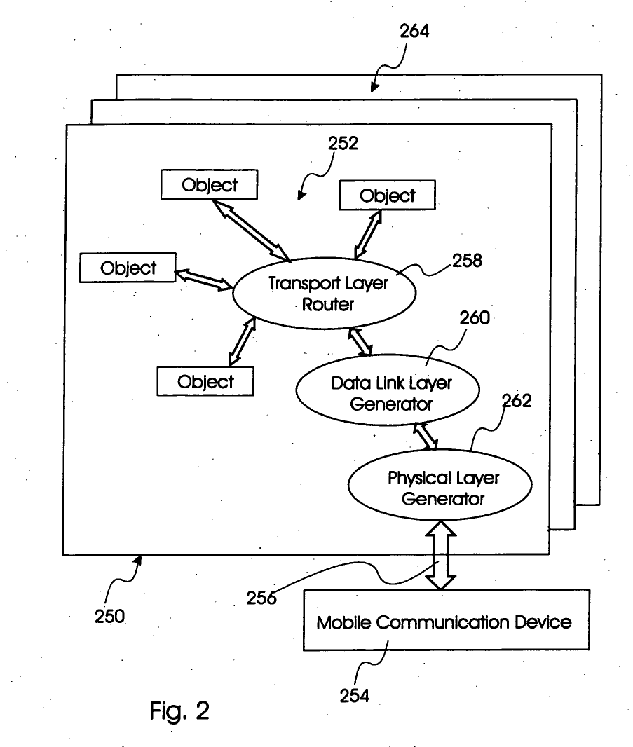

FIG. 2 shows a peripheral 250 having a plurality of objects, designated in entirety by reference numeral 252, which objects require communication to a mobile communication device 254. The peripheral 250 communicates with the mobile communication device 254 through a communication channel 256.

The plurality of objects 252 communicate application, presentation or session data to a transport layer router 258 establishing a transport layer message configured as shown in FIG. 1d as reference numeral 52. Subsequently, the transport layer message 52 is encapsulated by data link layer and physical layer fields in a data link layer generator 260 and physical layer generator 262, respectively.

Each object of the plurality of objects 252 is assigned an object identity, which is the CONNECTION_NO 52g when communicating with the mobile communication device 254.

The peripheral 250 may utilise one object for communicating with the mobile communication device 254. In this case said one object cannot communicate a request before having received a response for a previous request. When these limitations are met the peripheral 250 avoids using extensions 52i.

On the other hand the peripheral 250 may utilise each of the plurality of objects 252 to communicate transport layer messages independently. In this case each object may communicate several requests without waiting for responses to earlier communicated messages.

FIG. 2 further shows a plurality of peripherals 264 connected to the mobile communication device 254. In this case the mobile communication device 254 identifies each peripheral 264 using device identity associated with each peripheral. That is, an object of a first peripheral and an object of a second peripheral may have identical CONNECTION_NO, however, the mobile communication device 254 may distinguish between objects using the device identity incorporated in the data link layer header.

The transport layer protocol according to the preferred embodiment may be implemented on top of any data link layer protocol such as a data link layer protocol described in above referenced American and international patent applications by this applicant, or a data link layer protocol in accordance with Bluetooth RFCOMM.

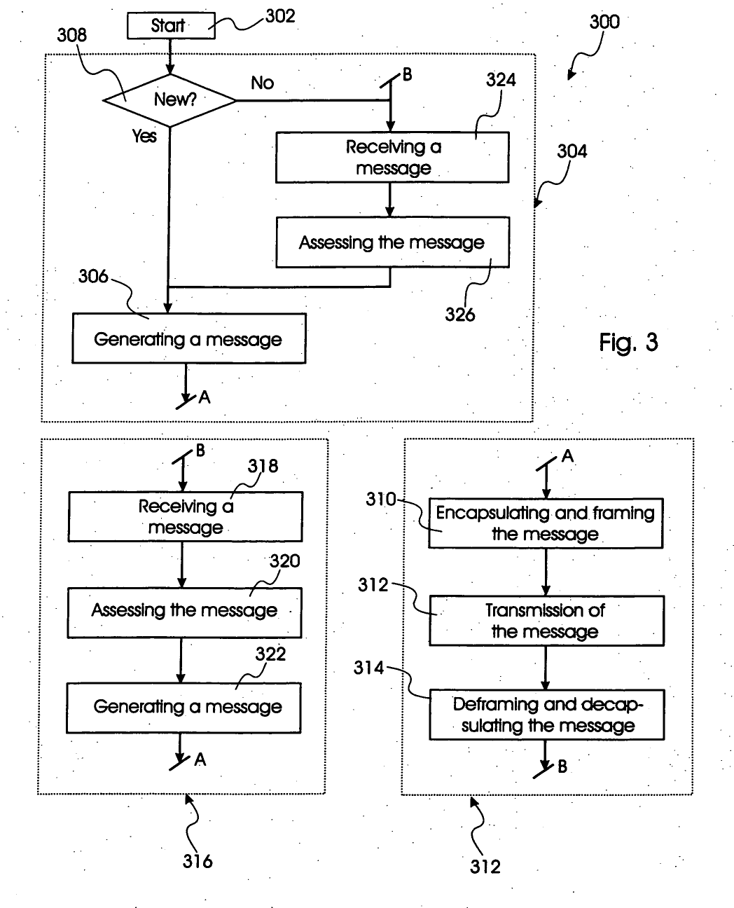

FIG. 3, shows a flow chart of an example of use of the system or rather the method 300 according to the preferred embodiment of the present invention. The method 300 initiates in start 302, where an application in the upper layers, namely application, presentation or session layers, issues a request, which in the following will be exemplified as a volume control communication.

The request is forwarded to the transport layer of a first module 304 such as a mobile phone, where the method 300 enters step 306 generating a message, which in the present example is a volume indication subscription request message, through step 308 since the message is a new message in a series of messages.

The message exits the transport layer of the first module 304 and enters through connection “A” step 310, which is a part of the physical and data link layer of the first and second module, shown together as reference numeral 312 for simplicity. During step 310 the message is encapsulated and framed by the transmitting module so as to generate a data package conforming with the data link and physical layer protocols. Subsequently, during step 312 the data package is transmitted through any type of connections. Lastly, the message is de-framed and de-capsulated from the data package during step 314 by the receiving module.

Through connection “B” the message enters the transport layer of the second module 316 such as a peripheral. The message is received during step 318 and assessed during step 320, which in the present example implies that a volume indication subscription request is processed. During step 322 a response is generated to the incoming message, i.e. a volume indication subscription response message is generated.

The transport layer of the second module 322 connects to the data link and physical layer through connection “A”.

The message, i.e. the volume indication subscription response is received at the transport layer of the first module 304 through connection “B” of the physical and data link layers 312. The volume indication subscription response is received during step 324 and assessed during step 326.

Obviously, the method 300 may be utilised for a wide variety of communication purposes between modules. For example, volume indication, which is a message sent from a mobile phone to a peripheral such as headset. The message is a stand-alone message thus if further information is required by the peripheral the peripheral must forward query message to the mobile phone.

1. A system for providing data communication between connected modules, wherein said modules are adapted to transmit to and receive from one another a data package comprising in a layered structure a physical layer comprising a first and a second segment for encapsulating other layers in said data package, a data link layer comprising a data link layer control section for carrying data link layer control data and a data section for carrying data for said other layers, and a transport layer defining a message in said data section, which message is configured according to a transport layer protocol and comprises a payload and a first header field for format of said payload, a second header field for start of said payload in said message, a third header field for length of said message, a fourth header field for version of said transport layer protocol, and a fifth header field for message group identity establishing receiving resource format of said payload.

2. A system according to claim 1, wherein said modules comprise a mobile communication device such as a cell, mobile or satellite telephone, a personal digital assistant, or a peripheral thereto.

3. A system according to claim 1, wherein said modules comprise one or more objects communicating said message with one another, and a data link layer generator and physical layer generator adapted to encapsulate said message according to a data link layer protocol and to a physical layer protocol, respectively.

4. A system according to claim 1, wherein said transport layer further comprises a sixth header field for a message identity for uniquely identifying said payload.

5. A system according to claim 1, wherein said transport layer comprises a seventh header field for a connection number for identifying a communicating object in said module.

6. A system according to claim 1, wherein said transport layer comprises an eight header field for a transaction identity for sequencing said message relative to other messages.

7. A system according to claim 1, wherein said data link control data comprises a checksum field following said message.

8. A system according to claim 1, wherein said first segment of said physical layer comprises a media field for defining media, across which the data package is transferred.

9. A system according to claim 1, wherein said first segment further comprises a synchronization field for synchronizing the receiving module with the transmitting module.

10. A system according to claim 1, wherein said second segment of the physical layer comprises an index byte for providing the receiving module with information regarding segmentation or partitioning of data contained in a message.

11. A system according to claim 1, wherein said second segment further comprises a sequence and acknowledge field for providing a receiving module with information whether said data package is an acknowledgement message or an ordinary message.

12. A system according to claim 1, wherein said second segment further comprises a sequence and an acknowledge field is adapted to inform whether an error was identified in the received data package, when said data package is an acknowledgement message.

13. A system according to claim 11, wherein said sequence and acknowledgement field is further adapted to inform a receiving module that a sequence number in said receiving module should be reset.

14. A system according to claim 11, wherein said sequence and acknowledgement field is adapted to recognise acknowledgement messages and detect missing data packages.

15. A system according to claim 1, wherein said second segment further comprises a fill field for ensuring that all data packages sent over said port connector contain an even amount of bytes.

16. A system according to claim 1, wherein said second segment further comprises a parity field for storing parity calculated on the basis of the data package excluding the parity field.

17. A system according to claim 1, wherein said transport layer comprises a ninth header field for a future extension comprising information required by a future transport layer protocol.

18. A data package for communicating between modules, wherein said data package, comprises in a layered structure physical layer, data comprising a first and a second segment for encapsulating other layers in said data package, a data link layer comprising a data link layer control section for carrying data link layer control data and a data section for carrying data for said other layers, and a transport layer defining a message in said data section, which message is configured according to a transport layer protocol and comprises a payload and a first header field for format of said payload, a second header field for start of said payload in said message, a third header field for length of said message, a fourth header field for version of said transport layer protocol, and a fifth header field for message group identity establishing receiving resource format of said payload.

19. A data package according to claim 18, said transport layer further comprises a sixth header field for a message identity for uniquely identifying said payload.

20. A data package according to claim 18, wherein said transport layer comprises a seventh header field for a connection number for identifying a communicating object in said module.

21. A data package according to claim 18, wherein said transport layer comprises an eight header field for a transaction identity for sequencing said message relative to other messages.

22. A data package according to claim 18, wherein said transport layer comprises a ninth header field for a future extension comprising information required by a future transport layer protocol.

23. A receiver unit adapted to receive a data package for communicating between modules, wherein said data package, comprises in a layered structure physical layer, data comprising a first and a second segment for encapsulating other layers in said data package, a data link layer comprising a data link layer control section for carrying data link layer control data and a data section for carrying data for said other layers, and a transport layer defining a message in said data section, which message is configured according to a transport layer protocol and comprises a payload and a first header field for format of said payload, a second header field for start of said payload in said message, a third header field for length of said message, a fourth header field for version of said transport layer protocol, and a fifth header field for message group identity establishing receiving resource format of said payload.

24. A transmitter unit adapted to transmit a data package for communicating between modules, wherein said data package, comprises in a layered structure physical layer, data comprising a first and a second segment for encapsulating other layers in said data package, a data link layer comprising a data link layer control section for carrying data link layer control data and a data section for carrying data for said other layers, and a transport layer defining a message in said data section, which message is configured according to a transport layer protocol and comprises a payload and a first header field for format of said payload, a second header field for start of said payload in said message, a third header field for length of said message, a fourth header field for version of said transport layer protocol, and a fifth header field for message group identity establishing receiving resource format of said payload.

25. A method for establishing data communication between modules, wherein said modules each communicate a data package comprising in a layered structure a physical layer comprising a first and a second segment for encapsulating other layers in said data package and a data link layer comprising a data link layer control section for carrying data link layer control data and a data section for carrying data for said other layers, and wherein said method comprising: providing in said data package in a transport layer a message in said data section, which message is configured according to a transport layer protocol and comprises a payload and a first header field for format of said payload, a second header field for start of said payload in said message, a third header field for length of said message, a fourth header field for version of said transport layer protocol, and a fifth header field for message group identity establishing receiving resource format of said payload.

26. A computer program comprising code adapted to perform the following steps when said program is run in a data processor adapted to establish data communication between modules, wherein said plurality of modules each communicate a data package comprising in a layered structure having a physical layer comprising a first and a second segment for encapsulating other layers in said data package and a data link layer comprising a data link layer control section for carrying data link layer control data and a data section for carrying data for said other layers, and wherein said program providing in a transport layer a message in said data section, which message is configured according to a transport layer protocol and comprises a payload and a first header field for format of said payload, a second header field for start of said payload in said message, a third header field for length of said message, a fourth header field for version of said transport layer protocol, and a fifth header field for message group identity establishing receiving resource format of said payload.
